(19) United States
(12) Patent Application Publication
(10) Pub. No.: US 2023/0160548 A1
(43) Pub. Date: May 25, 2023

(54) ILLUMINATING LAMP

(71) Applicant: Ningbo Huanya Electronics Co., Ltd, Ning Zhejiang Province (CN)

(72) Inventor: Shaolin Hu, Ningbo Zhejiang Province (CN)

(21) Appl. No.: 17/673,569

(22) Filed: Feb. 16, 2022

(30) Foreign Application Priority Data
Nov. 23, 2021 (CN) 202122882707.8

(51) Int. Cl. F21S 8/06; F21V 23/06; F21V 23/04; F21V 1/02; F21V 7/05

(52) U.S. Cl. CPC F21S 8/061; F21V 23/06; F21V 23/04; F21V 1/02; F21V 7/05

(57) ABSTRACT

The present disclosure discloses an illuminating lamp, comprising a housing, a lampshade and a lamp panel. The housing is provided with a driving device, an electric power input structure and an electric power output structure, and the electric power input structure is electrically connected to the electric power output structure and the driving device respectively; the lampshade is fixedly arranged on an outer side of the housing and forms an illuminating cavity with the housing; the lamp panel is arranged in the illuminating cavity, and the driving device is connected to the lamp panel via a wire to drive the lamp panel to operate and emit light. The present disclosure mounts a plurality of illuminating lamps, it is only needed to provide a socket connected to a mains supply in a mounting environment, and mounting is very convenient.

### TECHNICAL FIELD

The present disclosure relates to the field of illuminating lamps, in particular to a strip-shaped illuminating lamp.

### BACKGROUND

Illuminating lamps are indispensable electrical appliances in people's life, and it can provide light for people in the case of dark ambient light.

A strip-shaped illuminating lamp is one kind of the illuminating lamps, it includes a housing, a lampshade, and a lamp panel arranged between the housing and the lampshade, and it is an LED illuminating lamp which is used to replace of traditional lamps such as fluorescent tubes and neon lamps.

When a user mounts several existing strip-shaped illuminating lamps, a socket connected to the mains supply needs to be reserved for each strip-shaped illuminating lamp; when a plurality of strip-shaped lighting lamps are mounted, there are certain requirements for a mounting environment, and it is very troublesome and inconvenient for the user to mount a plurality of strip-shaped illuminating lamps.

### SUMMARY

In order to overcome defects in the prior art, the present disclosure provides an illuminating lamp which is provided with an electric power input structure and an electric power output structure so that when a user mounts a plurality of illuminating lamps, it is only needed to provide a socket connected to a mains supply in a mounting environment, and mounting is very convenient.

To achieve the foregoing objective, the present disclosure adopts the following technical solutions to implement:

an illuminating lamp, including:

a housing, which is provided with a driving device, an electric power input structure and an electric power output structure matching the electric power input structure, the electric power input structure being electrically connected to the electric power output structure and the driving device respectively;

a lampshade, which is fixedly arranged on an outer side of the housing and forms an illuminating cavity with the housing, and

a lamp panel, which is arranged in the illuminating cavity, the driving device being connected to the lamp panel via a wire to drive the lamp panel to operate and emit light.

With the above-mentioned structure adopted, it is very convenient for the user to mount a plurality of the illuminating lamps, and only one socket connected to the mains supply is required at a place of mounting, which greatly increase the applicable environments of the illuminating lamp.

During mounting, mounting of a first one of the illuminating lamps is completed near the socket connected to the mains supply, and the electric power input structure on it is connected to the socket connected to the mains supply; a second one of the illuminating lamps is mounted near the first one of the illuminating lamps, and the electric power input structure on the second one of the illuminating lamps is connected to the electric power output structure on the first one of the illuminating lamps; a third one of the illuminating lamps is mounted near the second one of the illuminating lamps, and the electric power input structure on a third illuminating lamp is connected to the electric power output structure on the second one of the illuminating lamps; by analogy, mounting of the illuminating lamps in a number required by the user is completed.

Specifically, the housing is provided with a wire passing hole at the illuminating cavity so as to facilitate routing of the wire between the driving device and the lamp panel, and a wire passing piece is arranged at the wire passing hole.

Further, the illuminating lamp is a strip-shaped illuminating lamp.

Further, the housing includes a housing body, and first end covers, the housing body has a driving cavity penetrating two ends thereof, and the driving device is arranged in the driving cavity; two side openings of the first end covers are arranged respectively at the two ends of the housing body in a covering mode so as to seal the driving cavity.

The lampshade includes a lampshade body, and second end covers, and the lampshade body is arranged on an outer side of the housing body and forms the illuminating cavity with two ends open with the housing body; two side openings of the second end covers are arranged respectively at two ends of the lampshade body in a covering mode so as to seal the illuminating cavity.

With the above-mentioned structure adopted, arrangement of the first end cover and the second end cover can prevent impurities such as dust from entering the driving cavity and the illuminating cavity, and facilitates integral mounting of the illuminating lamp.

Further, the first end cover and the second end cover located on the same side of the illuminating lamp are an integral piece and form a total end cover.

With the above-mentioned structure adopted, in production, personnel for mounting only need to perform mounting once, and then can seal an opening in the same side of the driving cavity and the illuminating cavity, so as to improve production efficiency and facilitate actual production.

Further, the total end cover is provided with an elastic clamping buckle, and correspondingly, the housing body is provided with fixing clamping grooves matching the elastic clamping buckles; and/or the total end cover is provided with a first fixing hole for a screw to pass through, the housing body is provided with a second fixing hole for a screw to pass through, and the first fixing hole is aligned with the second fixing hole in a state where the end cover is mounted on the housing body.

Further, the electric power input structure and the electric power output structure are respectively arranged at two ends of the housing.

When the illuminating lamp is the strip-shaped lamp, the above-mentioned structure is adopted to facilitate connection between the electric power input structure and the electric power output structure between two adjacent ones of the illuminating lamps.

Specifically, the electric power input structure and the electric power output structure are respectively arranged on the first end covers on two sides of the housing.

Further, the electric power input structure includes a male plug provided with plug bodies; the electric power output structure includes a female socket provided with jacks.

Further, the male plug is a three-wire plug; the female socket is a three-hole socket; the three-wire plug includes a null wire pin, a live wire pin and an earth wire pin, and the three-hole socket includes a null wire jack, a live wire jack and an earth wire jack; the null wire jack is electrically connected to the null wire pin, the live wire jack is electrically connected to the live wire pin, and the earth wire jack is electrically connected to the earth wire pin; the housing is at least partially made of metal; and the earth wire pin is electrically connected to a metal part of the housing.

A main body part of the housing in the housing is generally made of a metal material, and with the above-mentioned structure adopted, both the three-wire plug and the three-hole socket can make the metal part of the housing grounded, so as to ensure safety of the illuminating lamp during use, and avoid occurrence of accidents caused by an electric leakage phenomenon.

Further, the earth wire jack of the three-hole socket is electrically connected to the metal part of the housing and is electrically connected to the earth wire pin of the three-wire plug through the metal part of the housing or the earth wire jack of the three-hole socket is electrically connected to the earth wire pin of the three-wire plug directly.

Specifically, the housing is provided with grounding structures in the vicinity of the electric power input structure and the electric power output structure respectively in a state where the earth wire jack is electrically connected to the earth wire pin through the metal part of the housing.

The grounding structure includes an earth wire connecting head, a joint fixing piece provided with a fixing portion and a stop head, and a locking gasket matching the fixing portion; the housing is provided with a penetrating hole at a position where the grounding structure is arranged, and a hole diameter of the penetrating hole is greater than a diameter of the fixing portion and less than a diameter of the stop head and the locking gasket; the earth wire connecting head includes a wire connecting end and a mounting portion connected to the wire connecting end; the mounting portion is provided with a grounding mounting hole matching the fixing portion; the fixing portion of the fixing piece is matched with the locking gasket to be mounted after passing through the penetrating hole, the stop head and the locking gasket respectively abut against two sides of an end face of the housing provided with the penetrating hole, and the earth wire connecting head is mounted on the fixing portion via the mounting portion and abuts against the locking gasket; the wire connecting end of the earth wire connecting head is connected to the earth wire pin or the earth wire jack; and the earth wire connecting head, the joint fixing piece and the locking gasket are made of conductive materials, and the joint fixing piece is a screw.

Further, the illuminating lamp includes a pull switch for controlling an operating state of the lamp panel.

With the above-mentioned structure adopted, the user can operate the pull switch to open and close the illuminating lamp; specifically, the pull switch is connected to the driving device, and the driving device is used for receiving a signal of the pull switch to control the operating state of the lamp panel; and the pull switch is arranged on the first end cover.

Further, the illuminating lamp includes at least two hanging chains arranged on the housing for hanging the illuminating lamp.

With the above-mentioned structure adopted, the user can mount the illuminating lamp to a ceiling via the hanging chain; specifically, the illuminating lamp includes an S-shaped lifting hook, the housing is provided with a lifting hook fixing hole for one end of the S-shaped lifting hook to pass through for connection, and one end of the hanging chain is connected to the other end of the S-shaped lifting hook; two hanging chains are arranged, and are symmetrically arranged on the housing and the two hanging chains are respectively arranged close to the two ends of the housing, and the above-mentioned structure ensures mounting stability of the illuminating lamp.

Further, the first end cover includes a first bottom cover matching the opening of the driving cavity, and a first side wall formed when an edge of the first bottom cover extends towards a side of the housing body, and a matching portion formed when one end, facing the driving cavity, of the first side wall extends into the driving cavity;

the second end cover includes a second bottom cover matching the opening of the illuminating cavity, and a second side wall formed when an edge of the second bottom cover extends towards a side of the lampshade body, the second side wall and the second bottom cover form a limiting cavity, and an end portion of the lampshade body arranged in the limiting cavity.

The electric power input structure and the electric power output structure are arranged on the first bottom cover; the first fixing hole is formed in the matching portion, and the elastic clamping buckle is arranged at a connection position of the first end cover and the second end cover.

Further, two ends of a lampshade mounting face of the housing for mounting the lampshade extend on two sides of the lampshade to form light reflecting side plates, and the light reflecting side plates and the lampshade mounting face form a light reflecting hood.

With the above-mentioned structure adopted, it is possible to increase a utilization rate of light emitted from the lamp panel.

Further, the lampshade mounting surface includes a mounting main body surface, and connecting surfaces for connecting the mounting main body surface and light reflecting side plates, and one end of the connecting surface connected with the light reflecting side plate is inclined towards an opposite side of the lampshade mounting surface of the housing, and the light reflecting side plate is of an arc-shaped structure protruding to a side away from the lampshade.

With the above-mentioned structure adopted, the utilization rate of the light emitted from the lamp panel is further increased.

Further, the housing is provided with a pair of first slideways in a length direction thereof, the two ends of the lampshade are provided with hook-shaped insertion portions, and the insertion portions are inserted into the first slideways.

The housing is provided with a pair of second slideways in the length direction thereof, and the lamp panel is inserted into the second slideways.

Further, the lamp panel includes a substrate, and one or more rows of LED lamps in a length direction of the substrate.

Further, one end of the housing body close to the lampshade is provided with a wire passing hole facilitating passing of the wire for electrical connection between the driving device and the lamp panel, and a wire passing piece for storing the wire is detachably connected at the wire passing hole; where, the wire passing hole penetrates through one end of the housing body close to the first end cover to form an opening, and the wire passing piece is clamped inwards on the housing body along the opening; and the wire passing piece is provided with a cavity which is penetrating in a connection direction of the driving device and the lamp panel and used for the wire to pass through.

With the above-mentioned structure adopted, arrangement of the wire passing hole facilitates achieving the electric connection between the driving device and the lamp panel through the wire, and arrangement of the wire passing pieces facilitates storing the wire, thereby preventing the wire from being cluttered and providing higher safety.

Further, two ends of the wire passing piece are symmetrically provided with clamping grooves clamped with the housing body in a close fit mode; one end of each of the clamping grooves away from the first end cover is provided with two guide inclined surfaces, where, one guide inclined surface is formed by inclining towards a direction close to the driving device, and the other guide inclined surface is formed by inclining towards a direction close to the lamp panel.

Preferably, the clamping groove and the housing body are connected by a close fit.

With the above-mentioned structure adopted, the wire passing piece is tightly clamped on the housing body via the clamping groove, so that a structure is more stable and disengagement is less likely to occur; arrangement of the guide inclined surface facilitates positioning of the wire passing piece during mounting, and the guide inclined surface enables a width of the clamping groove located at the position to be greater than a thickness of the housing body, so that mounting is smoother.

Further, two end surfaces of the wire passing piece provided with the clamping grooves are both provided with isolation portions, and the isolation portions is formed by extending along the two ends of the wire passing piece provided with the clamping grooves towards the direction close to the driving device and the direction close to the lamp panel respectively.

With the above-mentioned structure adopted, the isolation portion is arranged so as to well separate the wire stored in a cavity thereof, and prevent the wire from coming into contact with other structures made of aluminum alloy materials, so that the structure is safer.

Further, one end of the wire passing piece close to the first end cover is provided with a notch formed in the connection direction of the driving device and the lamp panel; the wire passing piece includes a first front portion and a second front portion forming the notch, and a back portion is arranged at an end opposite the notch; the cavity is defined by the isolation portion with the back portion, the first front portion and the second front portion; and a top surface of the isolation portion is higher than a top surface of the back portion.

With the above-mentioned structure adopted, arrangement of the notch facilitates that there is a deformation margin when the wire passing piece is mounted to the housing body, so that mounting is smoother.

Further, the wire passing piece is made of a plastic material, so that it is insulating as a whole and safety is better.

Compared with the prior art, the present disclosure has the following beneficial effects.

(1) The illuminating lamp of the present disclosure is provided with the electric power input structure and the electric power output structure, so that when the user mounts the plurality of illuminating lamps, it is only needed to provide the socket connected to the mains supply in the mounting environment, and mounting is very convenient.

(2) The illuminating lamp of the present disclosure is safe in use.

(3) The illuminating lamp of the present disclosure is reasonable in structural design and convenient to popularize and use.

### BRIEF DESCRIPTION OF THE DRAWINGS

FIG. 1 is a schematic diagram of a three-dimensional structure of an illuminating lamp of the present disclosure.

FIG. 2 is a schematic diagram of a three-dimensional structure of an illuminating lamp of the present disclosure at another angle.

FIG. 3 is an exploded structure schematic diagram of the illuminating lamp of the present disclosure.

FIG. 4 is an enlarged view of the portion A in FIG. 3.

FIG. 5 is an enlarged diagram of the portion B in FIG. 3;

FIG. 6 is a schematic diagram of the wire passing piece of the illuminating lamp of the present disclosure.

FIG. 7 is an enlarged view of the portion C in FIG. 3.

FIG. 8 is an enlarged view of the portion D in FIG. 3.

FIG. 9 is a schematic diagram of a structure of matching of a housing body and a lampshade in the illuminating lamp of the present disclosure.

FIG. 10 is a schematic diagram of a grounding structure in the illuminating lamp of the present disclosure.

Reference numerals: 1 housing; 101 housing body; 102 first end cover; 1021 first bottom cover; 1022 first side wall; 1023 matching portion; 103 fixing clamping groove; 104 second fixing hole; 105 lampshade mounting surface; 1051 mounting main body surface; 1052 connecting surface; 106 light reflecting side plate; 107 first slideway; 108 second slideway; 109 wire passing hole; 1091, opening; 2 driving device; 3 electric power input structure; 4 electric power output structure; 5 lampshade; 501 lampshade body; 502 second end cover; 5021 second bottom cover; 5022 second side wall; 5023 limiting cavity; 503 insertion portion; 6 lamp panel; 7 illuminating cavity; 8 driving cavity; 9 total end cover; 901 elastic clamping buckle; 902 first fixing hole; 10 pull switch; 11 hanging chain; 12 S-shaped lifting hook; 13 grounding structure; 1301 earth wire connecting head; 13011 wire connecting end; 13012 mounting portion; 1302 joint fixing piece; 13021 fixing portion; 13022 stop head; 1303 locking gasket; 14 wire passing piece; 141, cavity; 142, clamping groove; 1421, guide inclined surface; 143, isolation portion; 144, notch; 145, first front portion; 146, second front portion; 147, back portion.

### DETAILED DESCRIPTION OF THE INVENTION

Specific implementations of the present disclosure are further described in detail hereafter in conjunction with accompanying drawings and embodiments. The described embodiments are used for illustrating the present disclosure, but are not intended to limit the scope of the present disclosure.

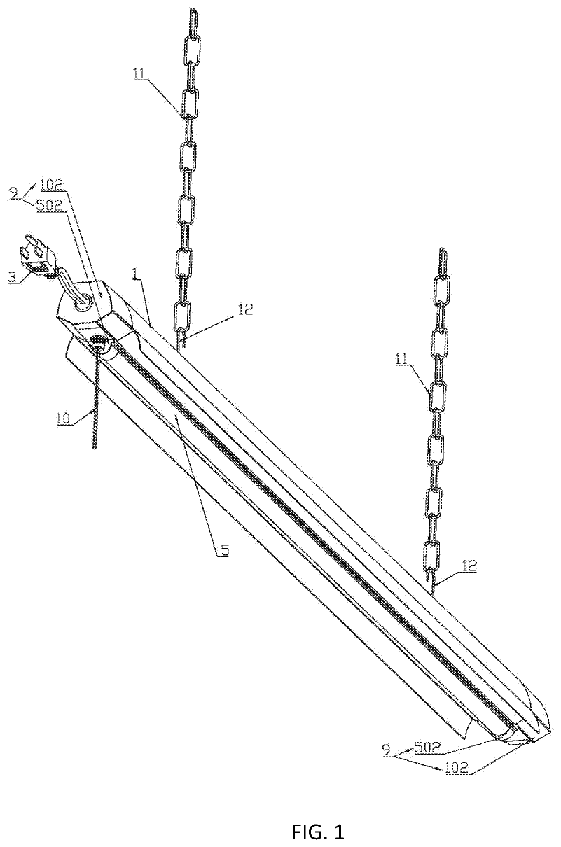

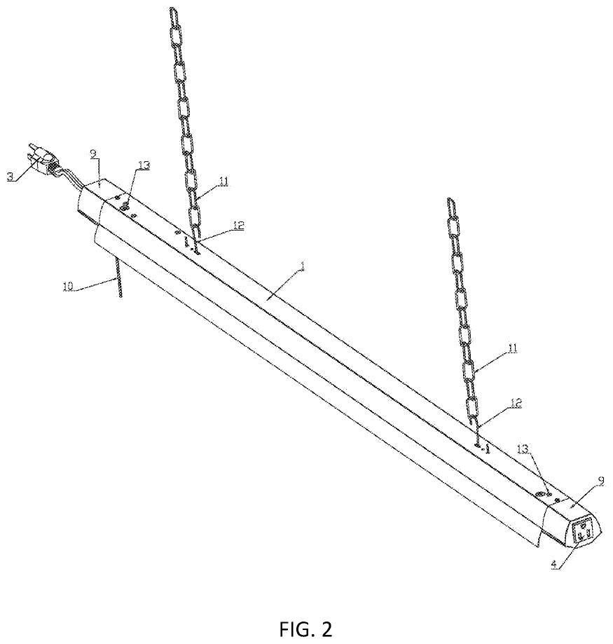

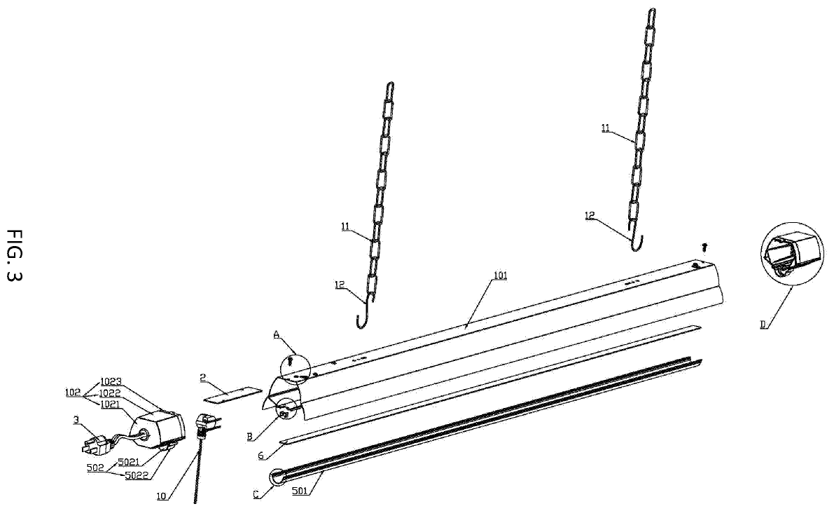

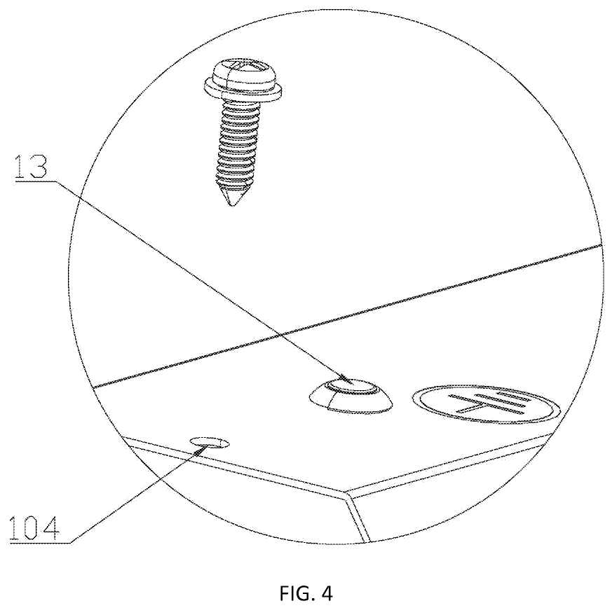

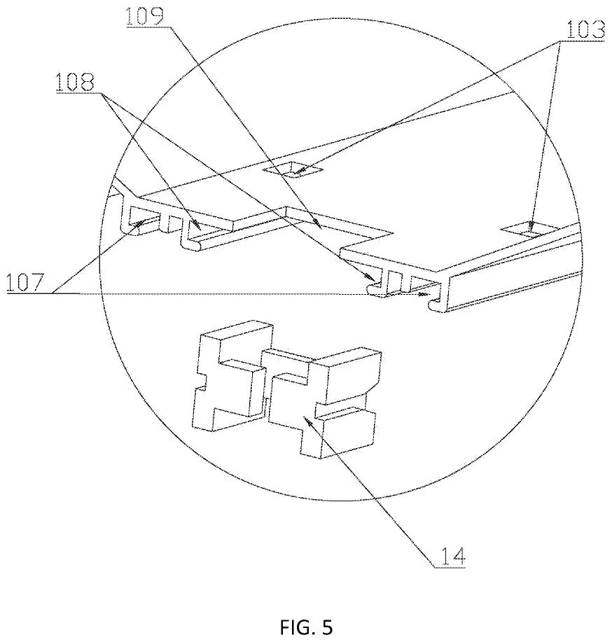

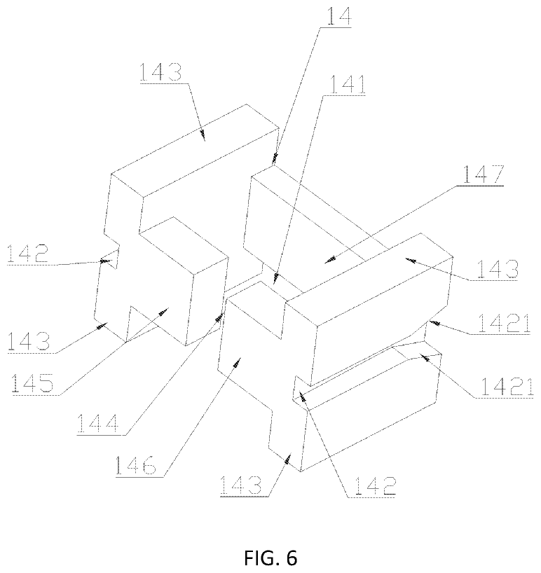

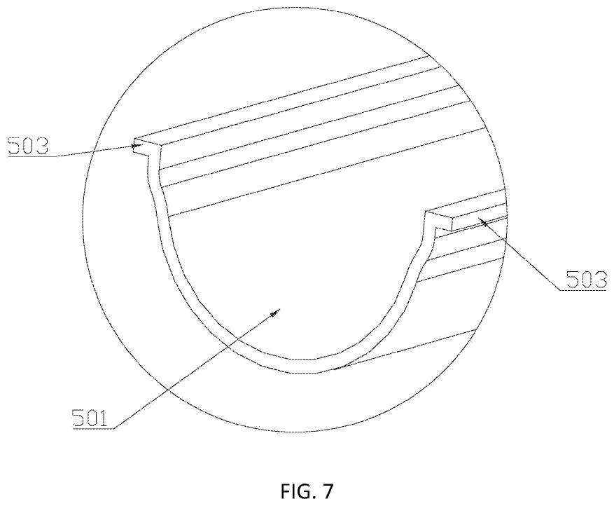

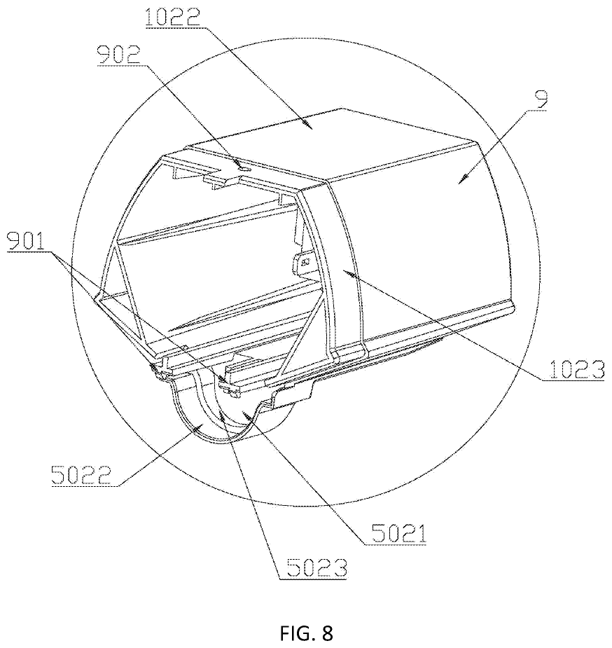

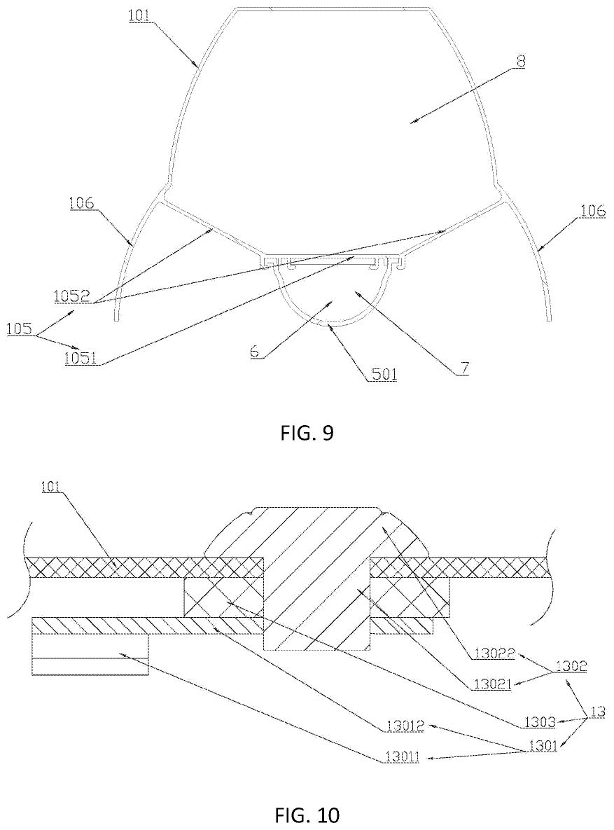

As shown in FIGS. 1-10, an illuminating lamp, including:

a housing 1, which is provided with a driving device 2, an electric power input structure 3 and an electric power output structure 4 matching the electric power input structure 3, the electric power input structure 3 being electrically connected to the electric power output structure 4 and the driving device 2 respectively;

a lampshade 5, which is fixedly arranged on an outer side of the housing 1 and forms an illuminating cavity 7 with the housing 1; and

a lamp panel 6, which is arranged in the illuminating cavity 7, the driving device 2 being connected to the lamp panel 6 via a wire to drive the lamp panel 6 to operate and emit light.

With the above-mentioned structure adopted, it is very convenient for the user to mount a plurality of the illuminating lamps, and only one socket connected to the mains supply is required at a place of mounting, which greatly increase the applicable environments of the illuminating lamp.

During mounting, mounting of a first one of the illuminating lamps is completed near the socket connected to the mains supply, and the electric power input structure 3 on it is connected to the socket connected to the mains supply; a second one of the illuminating lamps is mounted near the first one of the illuminating lamps, and the electric power input structure 3 on the second one of the illuminating lamps is connected to the electric power output structure 4 on the first one of the illuminating lamps; a third one of the illuminating lamps is mounted near the second one of the illuminating lamps, and the electric power input structure 3 on a third illuminating lamp is connected to the electric power output structure 4 on the second one of the illuminating lamps; by analogy, mounting of the illuminating lamps in a number required by the user is completed.

Specifically, the housing 1 is provided with a wire passing hole 109 at the illuminating cavity so as to facilitate routing of the wire between the driving device 2 and the lamp panel 6, and a wire passing piece 14 is arranged at the wire passing hole 109.

Further, one end of the housing body 101 close to the lampshade 5 is provided with a wire passing hole 109 facilitating passing of the wire for electrical connection between the driving device 2 and the lamp panel 6, and a wire passing piece 14 for storing the wire is detachably connected at the wire passing hole 109; wherein, the wire passing hole 109 penetrates through one end of the housing body 101 close to the first end cover 102 to form an opening 1091, and the wire passing piece 14 is clamped inwards on the housing body 101 along the opening 1091; and the wire passing piece 14 is provided with a cavity 141 which is penetrating in a connection direction of the driving device 2 and the lamp panel 6 and used for the wire to pass through. With the above-mentioned structure adopted, arrangement of the wire passing hole 109 facilitates achieving the electric connection between the driving device 2 and the lamp panel 6 through the wire, and arrangement of the wire passing pieces 14 facilitates storing the wire, thereby preventing the wire from being cluttered and providing higher safety. Further, two ends of the wire passing piece 14 are symmetrically provided with clamping grooves 142 clamped with the housing body 101 in a close fit mode; one end of each of the clamping grooves 142 away from the first end cover 102 is provided with two guide inclined surfaces 1421, wherein, one guide inclined surface 1421 is formed by inclining towards a direction close to the driving device 2, and the other guide inclined surface 1421 is formed by inclining towards a direction close to the lamp panel 6. Preferably, the clamping groove 142 and the housing body 101 are connected by a close fit. With the above-mentioned structure adopted, the wire passing piece 14 is tightly clamped on the housing body 101 via the clamping groove 142, so that a structure is more stable and disengagement is less likely to occur; arrangement of the guide inclined surface 1421 facilitates positioning of the wire passing piece 14 during mounting, and the guide inclined surface 1421 enables a width of the clamping groove 142 located at the position to be greater than a thickness of the housing body 101, so that mounting is smoother. Further, two end surfaces of the wire passing piece 14 provided with the clamping grooves 142 are both provided with isolation portions 143, and the isolation portions 143 is formed by extending along the two ends of the wire passing piece 14 provided with the clamping grooves 142 towards the direction close to the driving device 2 and the direction close to the lamp panel 6 respectively. With the above-mentioned structure adopted, the isolation portion 143 is arranged so as to well separate the wire stored in the cavity 141 thereof, and prevent the wire from coming into contact with other structures made of aluminum alloy materials, so that the structure is safer. Further, one end of the wire passing piece 14 close to the first end cover 102 is provided with a notch 144 formed in the connection direction of the driving device 2 and the lamp panel 6; the wire passing piece 14 includes a first front portion 145 and a second front portion 146 forming the notch 144, and a back portion 147 is arranged at an end opposite the notch 144; the cavity 141 is defined by the isolation portion 143 with the back portion 147, the first front portion 145 and the second front portion 146; and a top surface of the isolation portion 143 is higher than a top surface of the back portion 147. With the above-mentioned structure adopted, arrangement of the notch 144 facilitates that there is a deformation margin when the wire passing piece 14 is mounted to the housing body 101, so that mounting is smoother. Further, the wire passing piece 14 is made of a plastic material so that it is insulating as a whole and safety is better.

Preferably, the illuminating lamp is a strip-shaped illuminating lamp.

Preferably, the housing 1 includes a housing body 101, and first end covers 102, the housing body 101 has a driving cavity 8 penetrating two ends thereof, and the driving device 2 is arranged in the driving cavity 8; two side openings of the first end covers 102 are arranged respectively at the two ends of the housing body 101 in a covering mode so as to seal the driving cavity 8.

The lampshade 5 includes a lampshade body 501, and second end covers 502, and the lampshade body 501 is arranged on an outer side of the housing body 101 and forms the illuminating cavity 7 with two ends open with the housing body 101; two side openings of second end covers 502 are arranged respectively at two ends of the lampshade body 501 in a covering mode so as to seal the illuminating cavity 7.

With the above-mentioned structure adopted, arrangement of the first end cover 102 and the second end cover 502 can prevent impurities such as dust from entering the driving cavity 8 and the illuminating cavity 7, and facilitates integral mounting of the illuminating lamp.

Preferably, the first end cover 102 and the second end cover 502 located on the same side of the illuminating lamp are an integral piece and form a total end cover 9.

With the above-mentioned structure adopted, in production, personnel for mounting only need to perform mounting once, and then can seal an opening in the same side of the driving cavity 8 and the illuminating cavity 7, so as to improve production efficiency and facilitate actual production.

Preferably, the total end cover 9 is provided with an elastic clamping buckle 901, and correspondingly, the housing body 101 is provided with fixing clamping grooves 103 matching the elastic clamping buckles 901; and/or the total end cover 9 is provided with a first fixing hole 902 for a screw to pass through, the housing body 101 is provided with a second fixing hole 104 for a screw to pass through, and the first fixing hole 902 is aligned with the second fixing hole 104 in a state where the end cover is mounted on the housing body 101.

Preferably, the electric power input structure 3 and the electric power output structure 4 are respectively arranged at two ends of the housing 1.

When the illuminating lamp is the strip-shaped lamp, the above-mentioned structure is adopted to facilitate connection between the electric power input structure 3 and the electric power output structure 4 between two adjacent ones of the illuminating lamps.

Specifically, the electric power input structure 3 and the electric power output structure 4 are respectively arranged on the first end covers 102 on two sides of the housing 1.

Preferably, the electric power input structure 3 includes a male plug provided with plug bodies; the electric power output structure 4 includes a female socket provided with jacks.

Preferably, the male plug is a three-wire plug; the female socket is a three-hole socket; the three-wire plug includes a null wire pin, a live wire pin and an earth wire pin, and the three-hole socket includes a null wire jack, a live wire jack and an earth wire jack; the null wire jack is electrically connected to the null wire pin, the live wire jack is electrically connected to the live wire pin, and the earth wire jack is electrically connected to the earth wire pin; the housing 1 is at least partially made of metal; the earth wire pin is electrically connected to a metal part of the housing 1.

A main body part of the housing 1 in the housing 1 is generally made of a metal material, and with the above-mentioned structure adopted, both the three-wire plug and the three-hole socket can make the metal part of the housing 1 grounded, so as to ensure safety of the illuminating lamp during use, and avoid occurrence of accidents caused by an electric leakage phenomenon.

Preferably, the earth wire jack of the three-hole socket is electrically connected to the metal part of the housing 1 and is electrically connected to the earth wire pin of the three-wire plug through the metal part of the housing 1 or the earth wire jack of the three-hole socket is electrically connected to the earth wire pin of the three-wire plug directly.

Specifically, the housing 1 is provided with grounding structures 13 in the vicinity of the electric power input structure 3 and the electric power output structure 4 respectively in a state where the earth wire jack is electrically connected to the earth wire pin through the metal part of the housing 1.

The grounding structure 13 includes an earth wire connecting head 1301, a joint fixing piece 1302 provided with a fixing portion 13021 and a stop head 13022, and a locking gasket 1303 matching the fixing portion 13021; the housing 1 is provided with a penetrating hole at a position where the grounding structure 13 is arranged, and a hole diameter of the penetrating hole is greater than a diameter of the fixing portion 13021 and less than a diameter of the stop head 13022 and the locking gasket 1303; the earth wire connecting head 1301 includes a wire connecting end 13011 and a mounting portion 13012 connected to the wire connecting end 13011; the mounting portion 13012 is provided with a grounding mounting hole matching the fixing portion 13021; the fixing portion 13021 of the fixing piece is matched with the locking gasket 1303 to be mounted after passing through the penetrating hole, the stop head 13022 and the locking gasket 1303 respectively abut against two sides of an end face of the housing 1 provided with the penetrating hole, and the earth wire connecting head 1301 is mounted on the fixing portion 13021 via the mounting portion 13012 and abuts against the locking gasket 1303; the wire connecting end 13011 of the earth wire connecting head 1301 is connected to the earth wire pin or the earth wire jack; the earth wire connecting head 1301, the joint fixing piece 1302 and the locking gasket 1303 are made of conductive materials, and the joint fixing piece 1302 is a screw.

Preferably, the illuminating lamp includes a pull switch 10 for controlling an operating state of the lamp panel 6.

With the above-mentioned structure adopted, the user can operate the pull switch 10 to open and close the illuminating lamp; specifically, the pull switch is connected to the driving device 2, and the driving device 2 is used for receiving a signal of the pull switch 10 to control the operating state of the lamp panel 6; and the pull switch 10 is arranged on the first end cover 102.

Preferably, the illuminating lamp includes at least two hanging chains 11 arranged on the housing 1 for hanging the illuminating lamp.

With the above-mentioned structure adopted, the user can mount the illuminating lamp to a ceiling via the hanging chain 11; specifically, the illuminating lamp includes an S-shaped lifting hook 12, the housing 1 is provided with a lifting hook fixing hole for one end of the S-shaped lifting hook 12 to pass through for connection, and one end of the hanging chain 11 is connected to the other end of the S-shaped lifting hook 12; two hanging chains 11 are arranged, and are symmetrically arranged on the housing 1 and the two hanging chains 11 are respectively arranged close to the two ends of the housing 1, and the above-mentioned structure ensures mounting stability of the illuminating lamp.

Preferably, the first end cover 102 includes a first bottom cover 1021 matching the opening of the driving cavity, and a first side wall 1022 formed when an edge of the first bottom cover 1021 extends towards a side of the housing body 101, and a matching portion 1023 formed when one end, facing the driving cavity 8, of the first side wall 1022 extends into the driving cavity;

the second end cover 502 includes a second bottom cover 5021 matching the opening of the illuminating cavity 7, and a second side wall 5022 formed when an edge of the second bottom cover 5021 extends towards a side of the lampshade body 501, the second side wall 5022 and the second bottom cover 5021 form a limiting cavity 5023, and an end portion of the lampshade body 501 is arranged in the limiting cavity 5023.

The electric power input structure 3 and the electric power output structure 4 are arranged on the first bottom cover 1021; the first fixing hole 902 is formed in the matching portion 1023, and the elastic clamping buckle 901 is arranged at a connection position of the first end cover 102 and the second end cover 502.

Preferably, two ends of a lampshade mounting face 105 of the housing 1 for mounting the lampshade 5 extend on two sides of the lampshade 5 to form light reflecting side plates 106, and the light reflecting side plates 106 and the lampshade mounting face 105 form a light reflecting hood.

With the above-mentioned structure adopted, it is possible to increase a utilization rate of light emitted from the lamp panel 6.

Preferably, the lampshade mounting surface 105 includes a mounting main body surface 1051, and connecting surfaces 1052 for connecting the mounting main body surface 1051 and light reflecting side plates, and one end of the connecting surface 1052 connected with the light reflecting side plate 106 is inclined towards an opposite side of the lampshade mounting surface 105 of the housing 1, and the light reflecting side plate 106 is of an arc-shaped structure protruding to a side away from the lampshade 5.

With the above-mentioned structure adopted, the utilization rate of the light emitted from the lamp panel 6 is further increased.

Preferably, the housing 1 is provided with a pair of first slideways 107 in a length direction thereof, the two ends of the lampshade 5 are provided with hook-shaped insertion portions 503, and the insertion portions 503 are inserted into the first slideways 107.

The housing 1 is provided with a pair of second slideways 108 in the length direction thereof, and the lamp panel 6 is inserted into the second slideways 108.

Preferably, the lamp panel 6 includes a substrate, and one or more rows of LED lamps in a length direction of the substrate.

The above-mentioned is only a preferred embodiment of the present disclosure, and it should be noted that, for those skilled in the art, a plurality of improvements and embellishments can be made without departing from the technical principle of the present disclosure, and these improvements and embellishments should also be regarded as the protection scope of the present disclosure.

1. An illuminating lamp, comprising:
a housing (1), which is provided with a driving device (2), an electric power input structure (3) and an electric power output structure (4) matching the electric power input structure (3), and the electric power input structure (3) being electrically connected to the electric power output structure (4) and the driving device (2) respectively;
a lampshade (5), which is fixedly arranged on an outer side of the housing (1) and forms an illuminating cavity (7) with the housing (1); and
a lamp panel (6), which is arranged in the illuminating cavity (7), the driving device (2) being connected to the lamp panel (6) via a wire to drive the lamp panel (6) to operate and emit light.

2. The illuminating lamp according to claim 1, wherein the housing (1) comprises a housing body (101), and first end cover (102), the housing body (101) has a driving cavity (8) penetrating two ends thereof, and the driving device (2) is arranged in the driving cavity (8); two side openings of the first end covers (102) are respectively arranged on the two ends of the housing body (101) in a covering mode so as to seal the driving cavity (8); and
the lampshade (5) comprises a lampshade body (501), and second end covers (502), and the lampshade body (501) is arranged on an outer side of the housing body (101) and forms the illuminating cavity (7) with two ends open with the housing body (101); two side openings of the second end covers (502) are respectively arranged at two ends of the lampshade body (501) in a covering mode so as to seal the illuminating cavity (7).

3. The illuminating lamp according to claim 2, wherein the first end cover (102) and the second end cover (502) located on the same side of the illuminating lamp are an integral piece and form a total end cover (9); and
the total end cover (9) is provided with an elastic clamping buckle (901), and correspondingly, the housing body (101) is provided with fixing clamping grooves (103) matching the elastic clamping buckles (901); and/or the total end cover (9) is provided with a first fixing hole (902) for a screw to pass through, the housing body (101) is provided with a second fixing hole (104) for a screw to pass through, and the first fixing hole (902) is aligned with the second fixing hole (104) in a state where the end cover is mounted on the housing body (101).

4. The illuminating lamp according to claim 1, wherein the electric power input structure (3) and the electric power output structure (4) are respectively arranged at two ends of the housing (1).

5. The illuminating lamp according to claim 1, wherein the electric power input structure (3) comprises a male plug provided with plug bodies; the electric power output structure (4) includes a female socket provided with jacks.

6. The illuminating lamp according to claim 5, wherein the male plug is a three-wire plug; the female socket is a three-hole socket; the three-wire plug comprises a null wire pin, a live wire pin and an earth wire pin, and the three-hole socket comprises a null wire jack, a live wire jack and an earth wire jack; the null wire jack is electrically connected to the null wire pin, the live wire jack is electrically connected to the live wire pin, and the earth wire jack is electrically connected to the earth wire pin; the housing (1) is at least partially made of metal; the earth wire pin is electrically connected to a metal part of the housing (1);
the earth wire jack of the three-hole socket is electrically connected to the metal part of the housing (1) and is electrically connected to the earth wire pin of the three-wire plug through the metal part of the housing (1) or the earth wire jack of the three-hole socket is electrically connected to the earth wire pin of the three-wire plug directly.

7. The illuminating lamp according to claim 1, comprising: a pull switch (10) for controlling an operating state of the lamp panel (6).

8. The illuminating lamp according to claim 1, comprising: at least two hanging chains (11) arranged on the housing (1) for hanging the illuminating lamp.

9. The illuminating lamp according to claim 2, wherein the first end cover (102) comprises a first bottom cover (1021) matching the opening of the driving cavity, and a first side wall (1022) formed when an edge of the first bottom cover (1021) extends towards a side of the housing body (101), and a matching portion (1023) formed when one end, facing the driving cavity (8), of the first side wall (1022) extends into the driving cavity;
the second end cover (502) comprises a second bottom cover (5021) matching the opening of the illuminating cavity (7), and a second side wall (5022) formed when an edge of the second bottom cover (5021) extends towards a side of the lampshade body (501), the second side wall (5022) and the second bottom cover (5021) forming a limiting cavity (5023), and an end portion of the lampshade body (501) arranged in the limiting cavity (5023).

10. The illuminating lamp according to claim 1, wherein two ends of a lampshade mounting face (105) of the housing (1) for mounting the lampshade (5) extend on two sides of the lampshade (5) to form light reflecting side plates (106), and the light reflecting side plates (106) and the lampshade mounting face (105) form a light reflecting hood;
the lampshade mounting surface (105) comprises a mounting main body surface (1051),connecting surfaces (1052) for connecting the mounting main body surface (1051) and light reflecting side plates, and one end of the connecting surface (1052) connected with the light reflecting side plate (106) is inclined towards an opposite side of the lampshade mounting surface (105) of the housing (1), and the light reflecting side plate (106) is of an arc-shaped structure protruding to a side away from the lampshade (5).

11. The illuminating lamp according to claim 2, wherein one end of the housing body (101) close to the lampshade (5) is provided with a wire passing hole (109) facilitating passing of the wire for electrical connection between the driving device (2) and the lamp panel (6), and a wire passing piece (14) for storing the wire is detachably connected at the wire passing hole (109); wherein, the wire passing hole (109) penetrates through one end of the housing body (101) close to the first end cover (102) to form an opening (1091), and the wire passing piece (14) is clamped inwards on the housing body (101) along the opening (1091); and
the wire passing piece (14) is provided with a cavity (141) which is penetrating in a connection direction of the driving device (2) and the lamp panel (6) and used for the wire to pass through.

12. The illuminating lamp according to claim 11, wherein two ends of the wire passing piece (14) are symmetrically provided with clamping grooves (142) clamped with the housing body (101) in a close fit mode; one end of each of the clamping grooves (142) away from the first end cover (102) is provided with two guide inclined surfaces (1421), wherein, one guide inclined surface (1421) is formed by inclining towards a direction close to the driving device (2), and the other guide inclined surface (1421) is formed by inclining towards a direction close to the lamp panel (6).

13. The illuminating lamp according to claim 12, wherein two end surfaces of the wire passing piece (14) provided with the clamping grooves (142) are both provided with isolation portions (143), and the isolation portions (143) is formed by extending along the two ends of the wire passing piece (14) provided with the clamping grooves (142) towards the direction close to the driving device (2) and the direction close to the lamp panel (6) respectively.

14. The illuminating lamp according to claim 13, wherein one end of the wire passing piece (14) close to the first end cover (102) is provided with a notch (144) formed in the connection direction of the driving device (2) and the lamp panel (6);
the wire passing piece (14) includes a first front portion (145) and a second front portion (146) forming the notch (144), and a back portion (147) is arranged at an end opposite the notch (144); the cavity (141) is defined by the isolation portion (143) with the back portion (147), the first front portion (145) and the second front portion (146); and a top surface of the isolation portion (143) is higher than a top surface of the back portion (147).

15. The illuminating lamp according to claim 11 , wherein the wire passing piece (14) is made of a plastic material.
